(19) United States
(12) Patent Application Publication
(10) Pub. No.: US 2012/0284307 A1
(43) Pub. Date: Nov. 8, 2012

(54) String Searching Systems and Methods Thereof

(75) Inventors: Charles A. Meyer, Irving, TX (US); Jason A. Snyder, Hoboken, NJ (US); Kerry F. Gunther, Bethesda, MD (US); Patrick G. Peak, Bethesda, MD (US)

(73) Assignee: GOPOGO, LLC, Irving, TX (US)

(21) Appl. No.: 13/274,051

(22) Filed: Oct. 14, 2011

Related U.S. Application Data
(60) Provisional application No. 61/483,373, filed on May 6, 2011.

(51) Int. Cl. G06F 17/30

(52) U.S. Cl. 707/772; 707/769; 707/E17.018; 707/E17.014

(57) ABSTRACT

A system for generating a string based upon a plurality of places and a relationship between two or more of those places and for searching among the strings. Crosslinked databases contain information related to the strings, places within the strings, and users and creators of the strings. The strings represent an authentic user experience of a quality, character, and/or feel intended by the string author. The user experience can be further enhanced or guided through a narrative accompanying the string or places, written by the string author, that describes or invokes the quality, character or feel of the experience intended by the author.

### RELATED APPLICATION DATA

This application claims the benefit of priority of U.S. Provisional Patent Application Ser. No. 61/483,373, filed May 6, 2011, and titled “Geo-Location Based Playlist System and Method,” which is incorporated by reference herein in its entirety.

### FIELD OF THE INVENTION

The present invention generally relates to the field of web-based social interaction systems and methods. In particular, the present invention is directed to a computerized system and method of searching crosslinked strings, places, and people, where the strings include a plurality of places and a relationship established between those places.

### BACKGROUND

The ability to share various pieces of information between individuals has increased dramatically in the digital age with the advent of various devices and computer programs that allow for near real-time knowledge about an individual's activities and whereabouts. While the information shared by authors may be distributed widely, the information is often fragmented and disjointed, robbing authors and receivers of the information of a more complete understanding of the experience the author is attempting to communicate.

Various websites and applications adapted for mobile computing devices (“apps”) allow users to search and locate activities and places of interest. In some cases, an app used in conjunction with a mobile device having geolocation functionality may provide a display of activities (e.g., a movie) or places (e.g., a restaurant) of interest in relationship to the present location of the mobile device. Many known websites and apps search for, and locate, activities of interest when a static query is initiated by the user. Recommendations from this static query may be selected based on geographic proximity to the location of the mobile device.

For example, the Facebook® system allows users to periodically update a profile status, which may include a statement of current thoughts, an article the user is reading, a location the person is at, pictures the person has taken, and so forth. Facebook allows users to connect with other persons to create a social network, the other persons being able to view and comment on the profile status of the user. The user also receives the commentary of others in his or her network in time-sequence, thereby placing the most recent content of a person in the user's network as the first item to be reviewed by the user. The structure and organization of Facebook thereby allow for a review of a recent activity of a person by others, but fails to provide any connection between a multitude of activities of a user, which, when combined, disclose a more detailed and enriching experience.

### SUMMARY OF THE DISCLOSURE

An aspect of the present invention is a method of searching strings, comprising accessing a searchable database having a plurality of strings, each of which includes a plurality of places, with each place being identified by geolocation coordinates and included in at least one relationship correlating the each place with another place included in the string; and searching the searchable database for at least one of the plurality of strings using at least one of the relationships as a search term.

Another aspect of the present invention is a system for searching a plurality of strings, comprising: a computer readable storage medium connectable to a database, the database having a plurality of places stored therein; a geolocation module configured to record at least one coordinate representative of a position of a place stored in the database; an input module configured to receive characteristics of the place that are entered by a user; a string module configured to develop a relationship based upon at least two characteristics of the place, wherein the relationship correlates one of the plurality of places to another one of the plurality of places; and a search module configured to receive search characteristics from a user and to find at least one relationship matching the search characteristics.

Yet another aspect of the present invention is a method of searching strings, comprising: receiving a command to access a searchable database having a plurality of strings stored therein, each of which includes a plurality of places, with each place being identified by geolocation coordinates and included in at least one relationship correlating the each place with another place included in the string; and searching the searchable database for at least one of the plurality of strings using at least one of the plurality of relationships as a search term.

A further aspect of the present invention is a method of navigating a database having metadata values, comprising receiving a query term; querying the database based upon the query term; producing a first results list from the output of an algorithm configured to identify metadata values associable with the query term; selecting a first metadata value from the first results list; returning a second results list from the metadata values associated with the selecting; and selecting a second metadata value from the second results list.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic representation of a geolocation string building and searching system (GSBS) according to an embodiment of the present invention;

FIG. 1A is a schematic representation of a geolocation string building and searching system (GSBS) according to an embodiment of the present invention;

FIG. 1B is a block diagram of a string search engine according to an embodiment of the present invention;

FIG. 1C is a block diagram of crosslinked databases according to an embodiment of the present invention;

FIG. 2 is a block diagram of a taxonomy system according to an embodiment of the present invention;

FIG. 3 is a block diagram of a hierarchical organizational structure for strings according to an embodiment of the present invention;

FIG. 4 is a histogram of string frequency according to an embodiment of the present invention;

FIG. 5 is a flow diagram of a method of string searching according to an embodiment of the present invention; and

FIG. 6 is a schematic representation of a computer system suitable for use with GSBS according to an embodiment of the present invention.

### DETAILED DESCRIPTION

A geolocation string building and searching system (GSBS) of the present invention generates a string between two or more places designed by a user, where at least one of the places does not have associated taxonomy or other place related or entity related information (e.g., business hours, description of services, etc.). The string also includes a relationship, where the relationship is generated so as to establish a connection between the two or more places that, when performed, creates or allow for the re-creation of an authentic user experience. Information related to the string, user, and places designated by the user, (also referred to throughout as metadata), is stored in crosslinked databases that are easily navigable by a user. The user experience can be further enhanced or guided through a narrative accompanying the places, written by the string author, that describes or invokes the quality, character or feel of the experience intended by the author.

In addition to creating or allowing for the creation of information, GSBS facilitates the searching of the crosslinked databases of information. The databases searched by the GSBS include information generated by a number of users and, in an embodiment, include; a string database, which has a number of named strings that include at least two designated places and a relationship; a place database, which includes a named geolocation or address and can have information related to the entity located at each place; and a user database. The metadata included within each database is crosslinked such that a user can easily navigate through each database included with GSBS. In some implementations, a single database may be used, with partitions for the place, geolocation/address and user data.

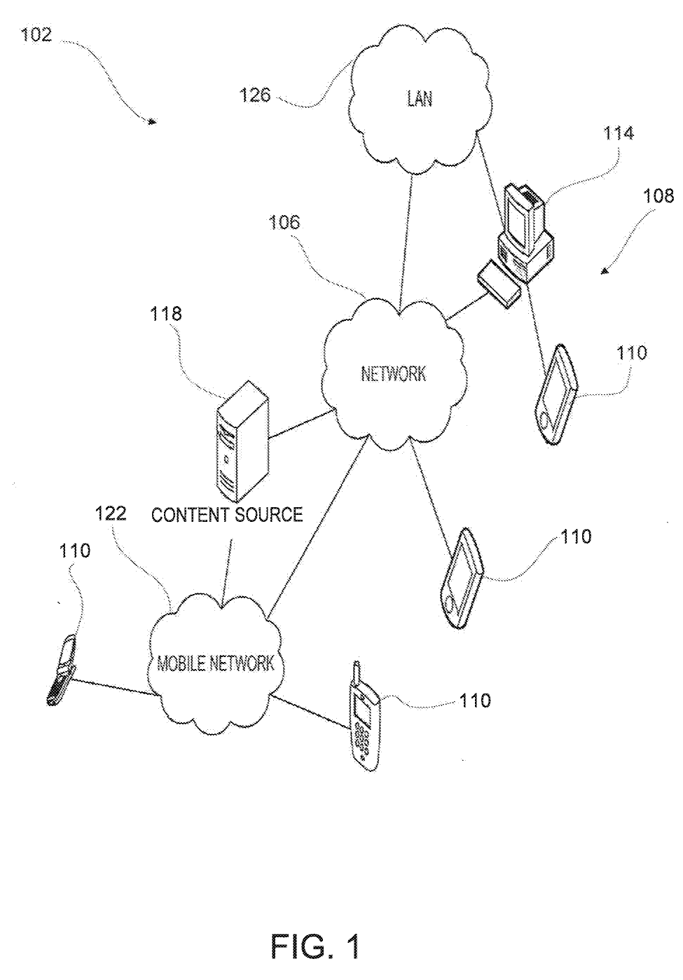

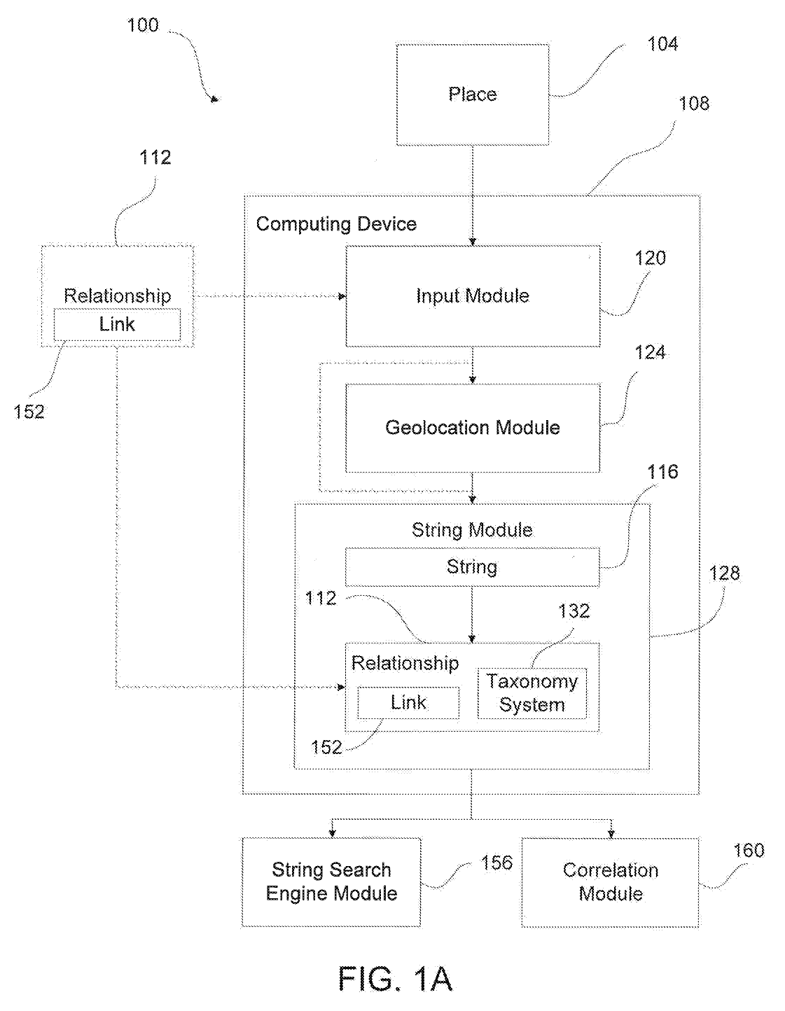

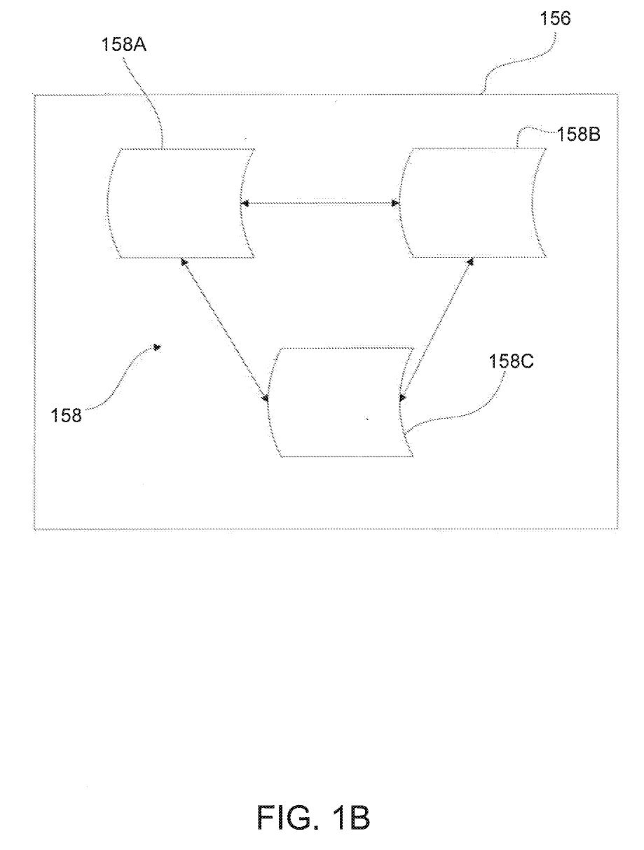

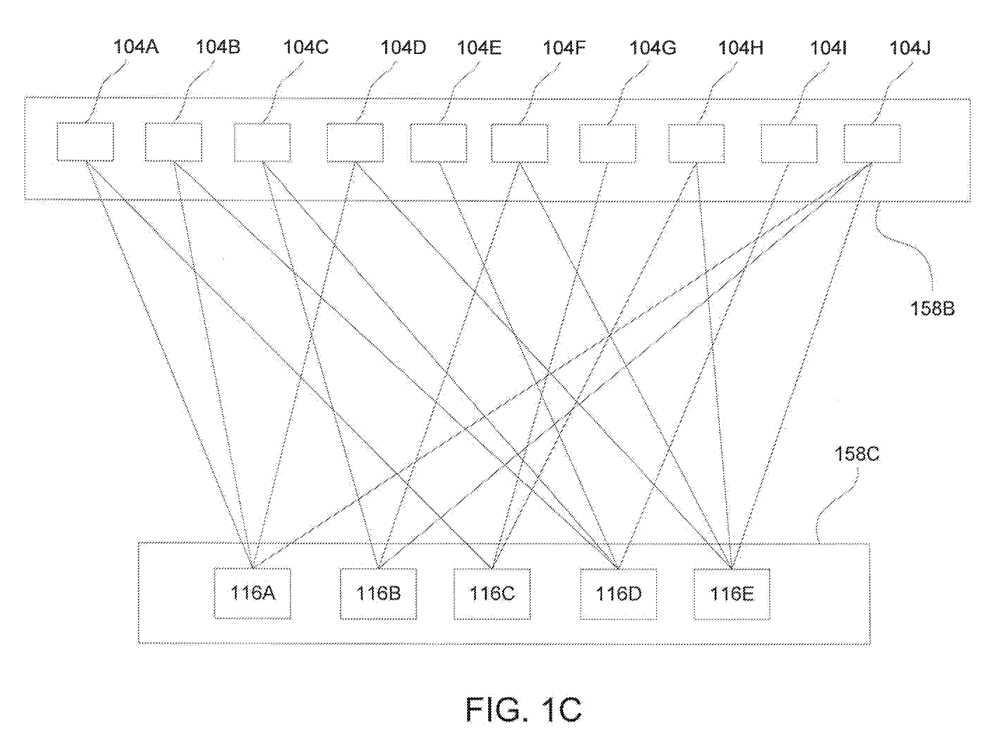

FIG. 1 illustrates an embodiment of a GSBS 100 configured to identify, communicate, select, and otherwise interact with an information system 102. Information system 102 may be used to communicate a wide variety of content, information, and/or data between components of information system 102, the content or information including, but not limited to, user preferences, user situational factors, including time, date, weather, and user location, or other information and content that can influence the character and performance of a string.

In an exemplary embodiment, information system 102 includes a network 106, one or more computing devices 108, such as mobile device 110 and computer 114, with the computing devices including some or all of GSBS 100. Computing device 108 may communicate with one or more components of information system 102, such as, but not limited to, other computing devices 108 and a content source 118. Computing device 108 may communicate to the aforementioned devices through network 106, mobile network 122, and/or local area network (LAN) 126, so as to access, record, store, retrieve or search information, such as place, user, string, and/or or relationship information (discussed in detail below with reference to FIG. 1A), in content source 118. Content source 118 can be, for example, a machine readable storage medium or a database, whether publicly accessible, privately accessible, or accessible through some other arrangement such as subscription, that holds, for example, information, data, programs, algorithms, or computer code, which is thereby accessible by computing device 108.

As those skilled in the art will appreciate, computing device 108 may take a variety of forms, including, but not limited to, a web appliance, a laptop computer, a desktop computer, a computer workstation, a terminal computer, web-enabled televisions, media players, and other computing devices in communication with network 106.

Network 106 may be used in connection with information system 102 to enable communication between the various elements of the information system that can include elements of GSBS 100. For example, as indicated in FIG. 1, network 106 may be used by computing device 108 to communicate with content source 118 for storing and retrieving information needed by GSBS 100. Network 106 may also allow for mobile device 110 to access certain software, algorithms, or other programs included with computing device 108. Those skilled in the art will appreciate that mobile device 110 can access information system 102 using any of a number of possible technologies including, mobile network 122, a cellular network, WiFi, wired internet access, combinations thereof, as well as others not recited, and for any of a number of purposes including, but not limited to, those reasons recited above.

GSBS 100 may also use information system as discussed in U.S. Provisional Application No. 61/483,373, filed May 6, 2011, and titled “Geo-Location Based Playlist System and Method,” to Meyer, to communicate between modules include with the GSBS. U.S. Provisional Application No. 61/483,373 is incorporated by reference for its discussion of the same. In an embodiment, communication between the modules included with GSBS 100 (discussed in detail below with reference to FIG. 1A) may be initiated through a webpage or application accessible on computing device 108. The website or application may be instantiated in a web-based environment existing on a web-page that is accessible through an information network, such as network 106. Computing device 108 may also use the information network to facilitate communication between the computing device and a content source, such as content source 118.

Turning now to FIG. 1A, geolocation relationship building and searching system (GSBS) 100 includes one or more software modules configured to allow for the designation of a place 104 by a user via a computing device 108, the generation of strings based upon the locations designated by the user, and the assignment of relationships to the strings. As discussed further below, one or more of the modules included with GSBS 100 facilitates the input of a designation of place 104 that the user is at, wishes to be at, or has been at before. The location of place 104 may be any geolocatable position, thereby allowing an author to enhance the experience by designating a unique place that is associated with other places the author wishes to include in his or her experience. Two or more of places 104 can then be assembled and be given or attributed a relationship 112, so as to create a string 116. In this way, a user may review, revise, distribute to other connections (e.g., other persons who are part of the user's social network), and allow to be viewed or searched, his or her strings 116 and provide an indication of the relationship associated with the string so as to enrich the experience for the others viewing, editing, or wishing to recreate the string. In an embodiment, string 116 may be considered a social media object, the social media object being communicable between others in the user's social network and/or creating a link for others to converge on a discussion or participation of the string.

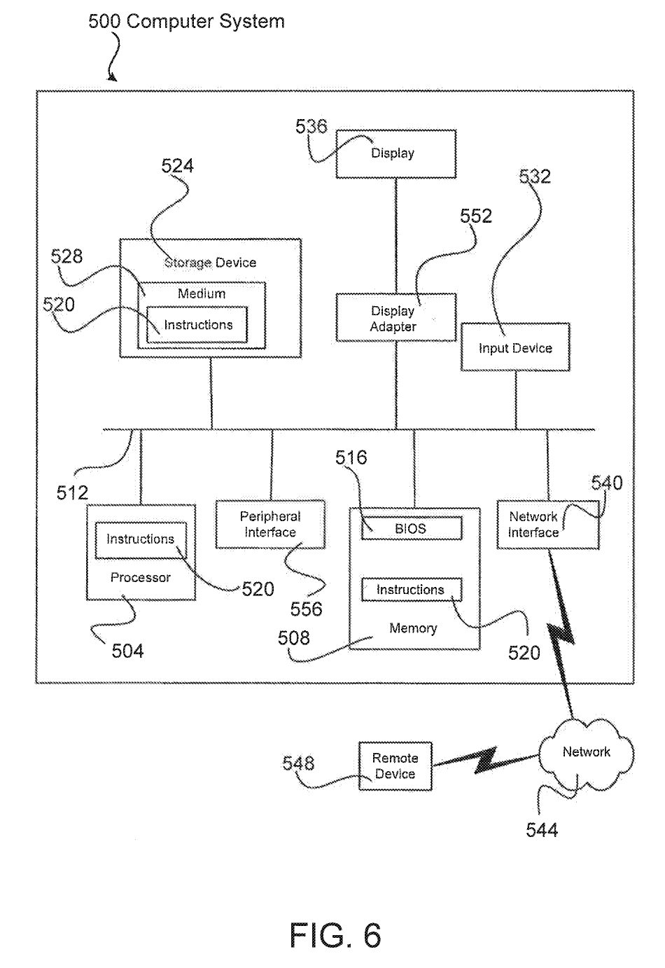

In an exemplary embodiment, GSBS 100 includes an input module 120, a geolocation module 124, and a string module 128. Input module 120 allows for inputting data, e.g., place 104, from a user into GSBS 100. In this embodiment, when GSBS 100 is included within a computing device 108, such as a mobile device, which may be, but is not limited to, a smartphone, global positioning system (GPS) device, or other mobile device having geolocation capabilities, input module 120 permits a user to designate any geolocatable place as a location. In this embodiment, a user may designate the location on computing device 108 by ways known in the art, such as, but not limited to, touching a spot on a touch screen, voicing a command, or directing a trackball. In alternative embodiments, such as when GSBS 100 is included with a computer system, such as computer system 500 (described below with reference to FIG. 6), a user may designate one or more locations via a website using a mouse or similar device.

Input module 120 may also allow a user to include other related information to the geolocatable place. For example, a user may input a time of arrival at the place, an experience the user had at the place, the type of event occurring at the place, and the like. A person of ordinary skill in the art should understand that some of the aforementioned pieces of related information may be generated automatically when the user designates a geolocatable place. For example, if the user designates a geolocatable place on computing device 108, e.g., by tapping a user interface element with a command such as “Record This,” the computing device may concomitantly record a time-stamp associated with the designation. The data input by a user into input module 120 may be stored in a one or more databases, such as databases 158 (described further below with reference to FIGS. 1B and 1C) for later retrieval or processing.

Geolocation module 124 is configured to act upon the request of the user, via input module 120, so as to identify and record the location of place 104, which in some embodiments may be a pair of coordinates (i.e., latitudinal and longitudinal) representative of the location of the user, the location of computing device 108, an address of a business, an event location, a website address, or other addressable or geolocatable places. It should be appreciated by those of ordinary skill in the art that location information can be obtained in a number of different ways. For example, location information can be retrieved via global positioning system (GPS) technology. In another example, a user carrying computing device 108 may be identified by a component of a computing network (e.g., a location server, a presence server, a router, etc.) that computing device is connected to. In another example, triangulation techniques using multiple cell towers can be used to determine computing device 108 location information. In yet another example, satellite locating techniques can be utilized to determine location information associated with computing device 108.

In an embodiment, computing device 108 includes technology for determining its location or ascertaining information associated with its location. Computing device 108 can then communicate that information to another entity, or another entity can retrieve that data from the computing device. When computing device 108 communicates with another device, the computing device is associated with identifying information such as addressing information, presence information, and the like. For example, computing device 108 can become associated with an internet protocol (IP) address, a MAC address, a network port, or any number of other types of addressing or locating information. IP addresses, MAC addresses, and others can be analyzed to ascertain information about the location of computing device 108. Alternatively, computing device 108 can utilize an address associated with another computing device, such as computing system 500 (discussed below with reference to FIG. 6), an internet service provider, a local area network, and the like. Communications can be monitored to detect, record, and analyze addressing information, presence information, and other types of information relevant to location information of computing device 108. In yet another embodiment, geolocation module 124 may be installed on a computing device and the data from input module 120 may be transferred over a network or via other means to the geolocation module 124.

String module 128 uses as inputs the two or more places 104 recorded by geolocation module 124 and can generate or be configured to accept a relationship 112, via input module 120, based on the two or more places so as to develop string 116. Places 104 are connected by relationship 112, which can be articulated by a user or inferred by or transferred to a string module 128, for example, through a global network information system such as an internet-based webpage or an app. Relationship 112 can include a theme, a narrative, or a trait that is common to places 104 of string 116 or otherwise unites the places so as to produce a cohesive user experience. Some factors that can be used to establish relationship 112 between places 104 of string 116 include, but are not limited to, geolocations of each place 104, the temporal proximity between places, the timeframe associated with the string (total time to visit/access all places in the string), cost of an activity at a place, place rating, author of the string, and/or the narrative supplied with the string that provides a description of the string experience. For example, temporal proximity of places 104 may be a component used to create a quality or type of experience intended by the author of string 116. In another example, temporal proximity can be used to establish relationship 112 between places 104 in the event that one of the places is accessible to users only within a defined period of time. In one embodiment, string 116 entitled “An Afternoon in Asia” could include as place 104 an Asian exhibit at a local museum, followed by a formal tea service at a Japanese tea house. This embodiment of string 116 includes an Asian theme relationship 112 as described, optionally, by a narrative, which includes the string title, explaining the connection between the two places 104 and uniting the places through a theme. In this embodiment, places 104 may also share relationship 112 of temporal proximity that is defined by the hours of operation of the museum and the Japanese tea house and have a timeframe such that the user experience of engaging in the two events is further captured.

The connection between the author and a string 116 created by the author can be further enhanced using an author's profile, which in some embodiments, may also provide context and information to assist in forming relationship 112. For example, an author can provide a narrative or description characterizing the author's preferences, persona, profession, activities, age, marital status, home town, neighborhood, hobbies, etc. In another example, an author can use existing online information to provide or inform the profile. Existing online information can include a Facebook® profile, information as to friends, places, comments, and activities extracted from a Facebook account or other similar social media forum. In yet another example, information (including meta-data) from an author's mobile phone, smart phone, or computer can be extracted to contribute to a profile. For example, hobbies, locations of friends and family, and so forth can be extracted based on internet browsing history and phone number data. Once populated and periodically updated, the information in the profile can be used to establish relationship 112.

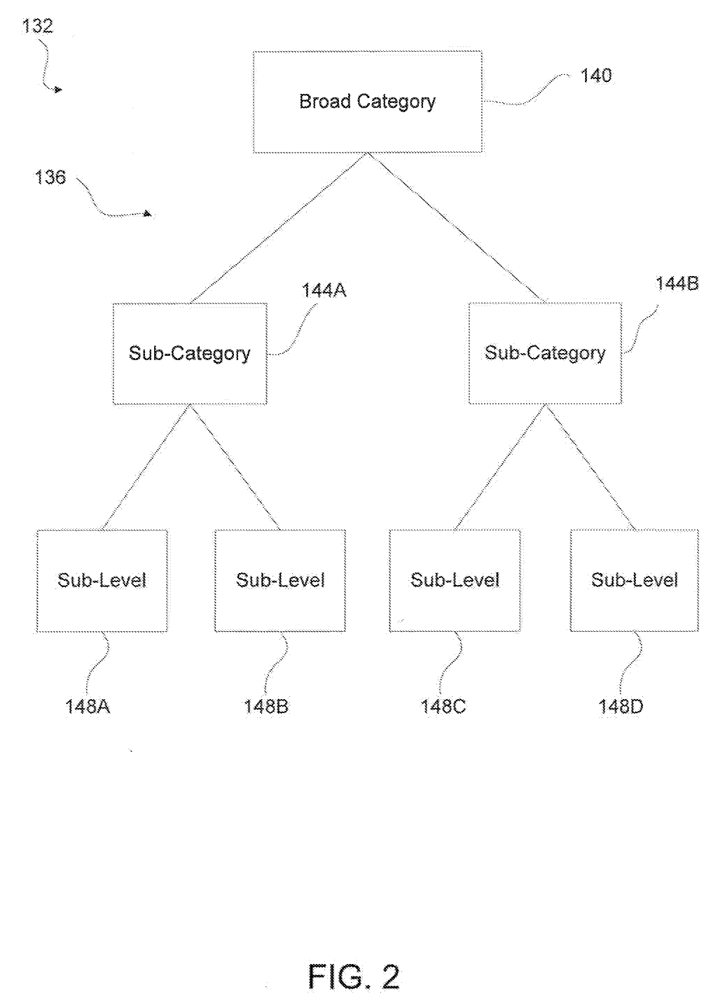

Relationships 112 can further be determined by categorizing traits of places and strings using a taxonomy system 132, shown in FIG. 2. In general, taxonomy refers to terms that may be associated with a place 104. In an embodiment, taxonomy system 132 can be structured to include a number of interrelated and associated category levels 136 that contain pre-defined place classifications. Category levels 136 are related such that a broad level category 140 includes one or more sub-categories 144, with, in certain embodiments, one or more sub-levels 148 disposed thereunder. This structure can be repeated to create a series of successively narrower sub-categories. For example, and as shown in FIG. 2, broad category level 140 could be “stores” with successively narrower sub-categories including “musical equipment stores” (sub-category 144A) with sub-levels including “piano stores” and “antique piano stores,” (sub-levels 148A-B, respectively) and “sports stores” (sub-category 144B) with sub-levels including “racquet sports” and ball sports, (sub-levels 148C-D, respectively). Classifications from broad category 140, any one or more sub-categories 144, or sub-levels 148 can then be assigned to places 104 or strings 116 to characterize the place, relationship 112 between places, or a string. Classifications can also be used to facilitate searching.

In addition to taxonomy, “folksonomy” can be used to develop an organization of places and strings using colloquial terminology and characterizations provided over time by users. In general, folksonomy does not initially include category levels 136, as the terms associated with the place are not predetermined. For example, a folkonomy can develop either through an affirmative solicitation by GSBS 100 for characterizations submitted by users or through an examination performed by the GSBS of user-provided narratives. In another example, GSBS 100 can search for and determine whether multiple users describe or characterize the same place 104 using recurring themes or terms. These recurring themes or terms can then be applied in the same way as a taxonomy 132, and used to describe or classify places 104, strings 116, authors, relationships 112, or the quality of experience.

String 116, as discussed above, includes at least two places having a location. In this context, the term “location” is intended to be defined broadly. That is, and in coordination with geolocation module 124, a location can include any geolocatable place. For example, a location can include an address of a physical place, whether a street address, an intersection name, a location identified by a landmark, or a GPS coordinate, also known as a geolocation position.

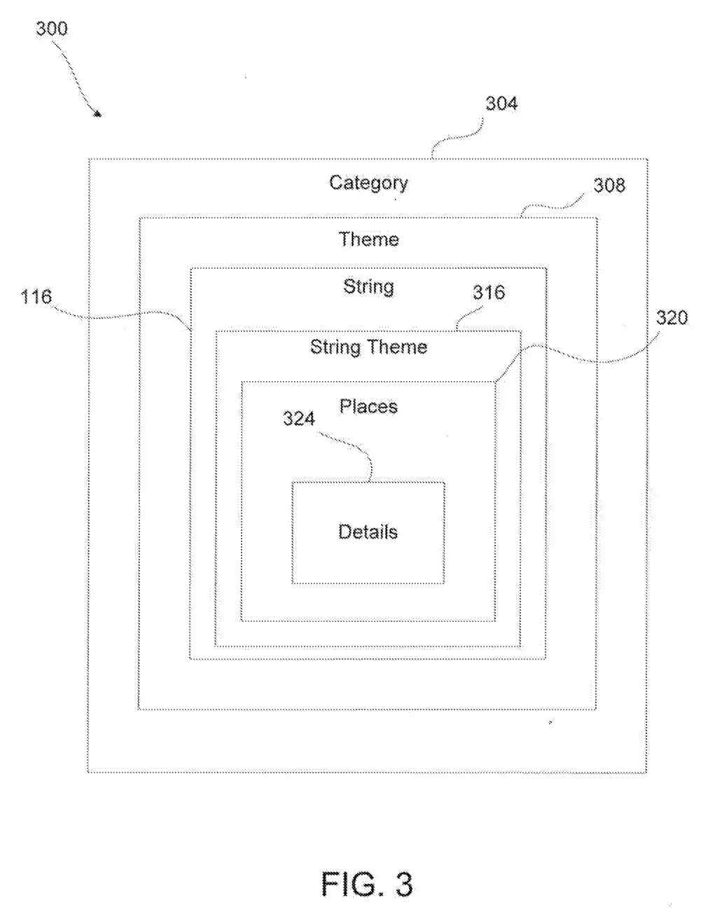

In some embodiments, places 104 and strings 116 can be hierarchically organized under themes and subthemes. FIG. 3 schematically depicts an example of such a hierarchical structure 300 for strings 116. String 116 presented to a user may be organized within one or more categories 304 within hierarchical structure 300. Each category 304 may, in some embodiments, have a unique theme 308 that is common to strings 116 within the category, but differs from the themes of the other categories. In other embodiments, the categories 304 in string 116 may have a similar theme or even the same theme. Similar to the diversity possible between the various categories 304, the strings 116 within a given category may also be distinct from each other while remaining consistent to the theme of the overarching category.

As shown in FIG. 3, each string 116 may include a unique string theme 316, wherein each string theme is consistent with the overarching category theme and the second theme of the hierarchical structure. As mentioned previously, strings 116 may include a plurality of places 320 (which may be places 104), e.g., visiting a garden, dining at a specified restaurant, and watching a show. As with strings 116 within category 304, places 320 may, in some examples, be diverse from each other, but nonetheless consistent with both the first theme of category 304 and the second theme of string 116. In some cases, it may be desirable to associate details 324 with one or more places 320, including, but not limited to, user comments, promotions and special offers, and the ability to invite others to a destination or string. As discussed more below, in some cases a user may provide details 324 and in other cases the details may be provided by the entity operating GSBS 100. In the former case, for example, a user may add an alternative destination to string 116, through suitable user interface functionality, e.g., input module 120, or a web-based database of places that are searchable and selectable by the user. GSBS 100, in one embodiment is structured so that any additions to string 116 added by a user are consistent with the themes of the string 116 and category 304 in which the destination is added. In other embodiments, such limitation may not be desired. Interface functionality in string 116 may also permit a user to rate the string, and rate the author of the string, thereby providing additional information. Other details 324 may also be added to places 316, as those skilled in the art will appreciate.

Returning now to FIG. 1, each relationship 112 includes one or more links 152. In general, links 152 are specific elements of relationship 112. For example, link 152 can be a temporal link between each place identified in the string. A temporal link can be important to certain types of strings 116 because the string may need to be completed within a certain time frame in order to properly characterize the user's experience at those places 104 or for other reasons. Additionally, for some strings 116, the sequence of events may require that certain places 104 be visited at certain times. For instance, if an exemplary string 116 includes three places, such as, a restaurant, a park bench, and a comedy club, and the show at the comedy club has a certain start time, going to the restaurant and then the park bench would require a certain timing so as to afford a reviewer of the string an opportunity to experience the relationship associated with the string. In another embodiment, link 152 may be physical proximity. In yet another embodiment, link 152 may be theme or narrative designated by the user. In a further embodiment, link 152 may be a combination of one or more of the above referenced items.

GSBS 100 may also include a string search engine 156. String search engine 156 facilitates the searching of existing strings 116, places 104, and users located in one or more databases 158. String search engine 156 may be configured to allow for searching of strings 116, places 105, or users using a variety of different criteria. For example, string search engine 156 may search existing strings 116 by the user who input the string. In another example, string search engine 156 may search existing strings 116 by place 104. In yet another example, string search engine 156 may search existing strings 116 by proximity to a desired location, for instance, if a searcher would like to view all of the strings located near a certain location or destination, e.g., Boston, MA; Stowe, VT; etc. In this example, string search engine 156 would return all strings 116 in the locale designated by the searcher. In yet a further example, string search engine 156 may allow a search by places 104 associated with a string 116. In this example, a place of interest would be input into string search engine 156 and the string search engine would return all of those strings 116 that included the place of interest.

An exemplary embodiment of a search string engine 156 is shown in FIG. 1B. As mentioned above, search string engine 156 can include a number of databases 158, e.g., people database 158A, place database 158B, and string database 158C. For example, the string may be stored in a database, the database suitable for storing tens of thousands, if not millions, of strings or more. This initial string may then be compared to other strings in the database. The comparison may allow for the initial string to be categorized among other strings such that the other strings may be suggested to the author of the initial string. Alternatively, and as discussed above, the comparison may involve determining a frequency of occurrence of the two places or types of relationships that occur.

People database 158A can include metadata information such as, but not limited to, user name, user account information, location, association with authored strings 116, traces, followers, following, and places, as well as activity information. Place database 158B can include metadata information such as, but not limited to, place name, address, phone number, web address, classification, and taxonomy information. String database 158C can include metadata information on places 104 included within each respective string 116, names and/or descriptions of places 104 included in strings 116, time of visitation or access to place 104, rating of each string 116, and reviews of string 116.

As shown in FIG. 1B, each database is interconnected thereby providing string search engine 156 with the ability to return results from each of the databases. For example, if a user searches on the term “pizza,” the results can include persons with the name “pizza,” places that sell pizza, and strings that include the term “pizza” in one of the fields of the database. In an exemplary embodiment, the results from string search engine 156 can be segmented by database. For example, if only places including the term “pizza” are desired, the user can select this option.

Databases 158 can be crosslinked, such the data included in each respective database can be navigated along a nodal network. For example, and as shown in FIG. 1C, a plurality of strings may be included in string database 158C and represented by strings 116A-E, with each string including some of a plurality of places 104A-104J. In this example, string 116A includes places 104A, 104B, 104D, and 104J; string 116B includes places 104C, 104F, and 104J; string 116C includes places 104A, 104G, and 104H; string 116D includes places 104B, 104C, 104E, and 1041; and string 116E includes places 104D, 104F, and 104J. Crosslinking between databases 158 is found in those instances in which strings share a common place. Thus, in the example presented above, string 116A is crosslinked with string 116E at place 104J.

Crosslinking enables a user to quickly and easily navigate databases 158 associated with string search engine 156. For example, and with reference to FIGS. 1B and 1C, a searcher can start by inputting a search term into string search engine 156. In an embodiment, string search engine 156 can return users, places 104, and strings 116 that include the search term. If the result includes a user, the searcher can select the user and review information associated with the user, such as, but not limited to, strings 116 that that user has created, is following, has traced or recreated. The searcher can then select, for example, one of the strings 116 that the user has created and review all of the places 104 associated with the string. By selecting one of places 104 included with the selected string 116, the searcher can review other strings and other users associated with the same place. The navigational aspects of the crosslinked databases 158 allow a searcher to follow the strings created by others while further expanding the range of possibilities for establishing additional relationships between places 104.

GSBS 100 may also include a correlation module 160. Correlation module 160 assists in determining various relationships between one or more places 104 designated by a user. In an embodiment of correlation module 160, the correlation module can determine, based upon strings 116, a frequency of occurrence of a sequence of places 104 across multiple strings. The frequency of occurrence can indicate a strong or preferred relationship between two or more places 104.

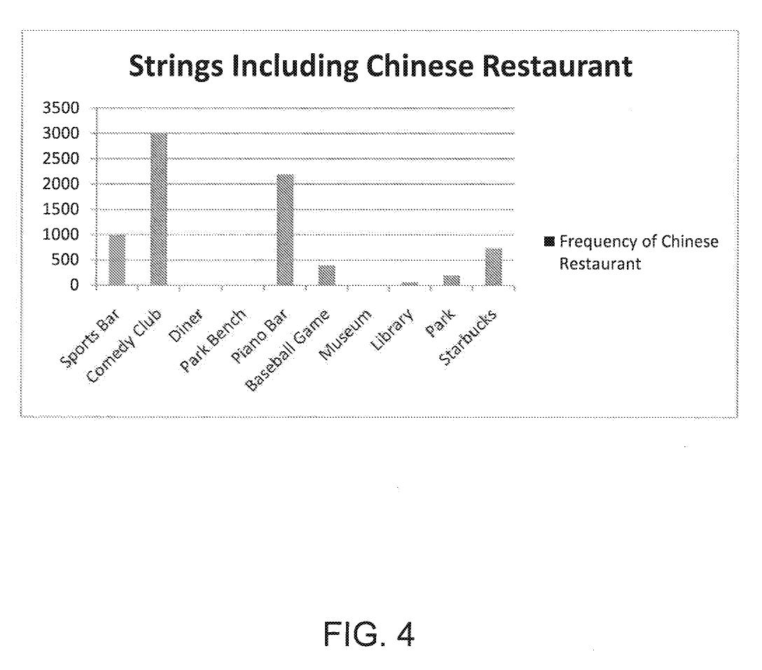

For example, and as shown in FIG. 4, a histogram displays the frequency of strings 116 that have in common at least one place 104, which, in this example, is a Chinese restaurant (the “Chinese restaurant strings”). The Chinese restaurant is not shown in FIG. 4. The other places 104 included within the Chinese restaurant strings are, a sports bar, a comedy club, a diner, a park bench, a piano bar, a baseball game, a museum, a library, a park, and a Starbucks® coffee shop. As shown in the histogram in FIG. 4, the comedy club is the place most frequently associated in strings 116 with the Chinese restaurant. Correlation module 160 determines such associations, which can subsequently be used to suggest the comedy club to other persons using GSBS 100 who may be desiring an experience involving the Chinese restaurant and an additional place 104. Thus, correlation module 160 may develop a relationship 112 based upon user behavior with regard to two or more places 104.

For example, because a user can indicate his arrival at a first place 104 (Chinese restaurant) using computing device 108, or such arrival can be automatically detected, GSBS 100 can make correlations using correlation module 160 to point the user to other places based on frequency and temporal proximity data sent by users. As another example, referring to the preceding embodiment, GSBS 100 can correlate the Asian exhibit at the museum with the Japanese tea house based on the frequency of user visits, and the temporal proximity between visits to places 104. This relationship 112 can then be used for a number of purposes, including alerting the user of this previously unrecognized correlation or creating a string 116 that includes the correlated places 104.

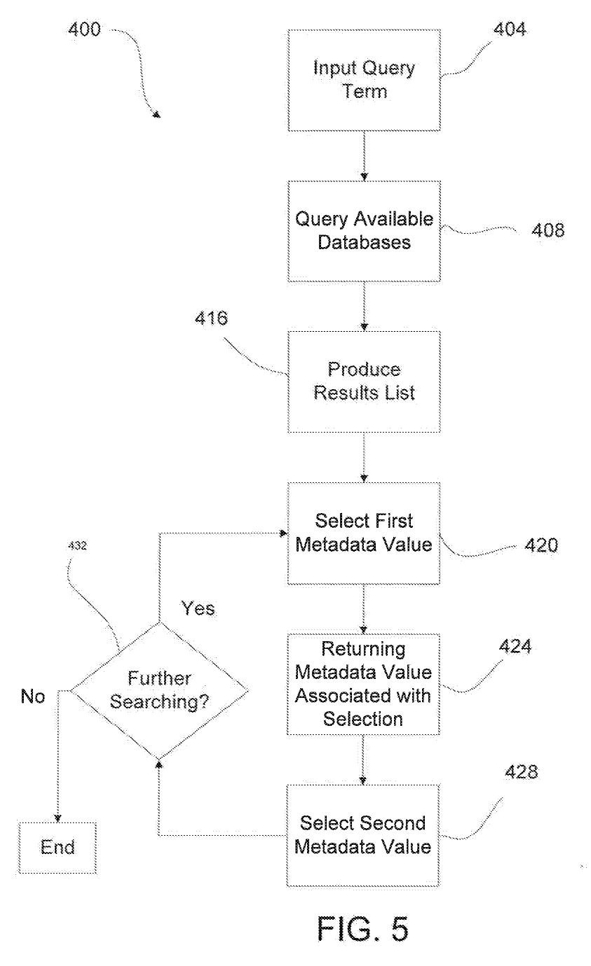

Turning now to FIG. 5, a method 400 of searching using a search string engine, such as string search engine 156, is depicted. At step 404, a query term is input into the string search engine. The query term can be a single term, a group of terms, with or without Boolean operators, or can be selected from a list of possible terms via, for example, a drop down menu or list. For example, the query term may be a specific place, the approximate location of the searcher, or the GPS coordinates of the searcher. The place can be any place having an address or geolocatable position. In an example, the place has an associated with it a window, which is a time period in which the first place was visited or accessed. The first place may also include entity related information. As discussed previously, entity related information can be information that is publically accessible via an information source (e.g., website) about the place. Examples of entity related information may be hours of operation, entity type, entity character, or entity services.

At step 408, string search engine 156 queries any databases associated with the string search engine. The string search engine can search for exact or approximate matches to the query term, via methodologies known in the art.

At step 412, a results list is produced by string search engine 156 and presented to the searcher. In an embodiment, the results list includes matches to the query term and metadata values associated with the match. In this embodiment, at least some of the metadata values associated with the match is crosslinked to other databases connected to string search engine 156. For example, if the match is a string 116, metadata values associated with the string would include the places 104 designed by the string author and the relationship between the places, and could include a narrative written by the author.

At step 420, a metadata value is selected, such as one of the metadata values representing a place 104 associated with a string 116. Upon selection, at step 424 the metadata associated with the new selection can be displayed, which also includes metadata values that are crosslinked to other databases connected to string search engine 156. Continuing the example from just above, if a place 104 in a string 116 is selected at step 420, the place and its associated metadata would be displayed. Included with this metadata would be all strings 116 that included the selected place 104.

At step 428 another metadata value is selected. Continuing with the example above, a searcher can select a metadata value associated with a place that is a string 116 including the place 104. The searcher is then presented with all the metadata values associated with the string, including, all of the places that are included with the string and the relationship with the string.

At step 432 a determination is made as whether further searching is required. Should the searcher chose to do so, the process returns to step 420, where a metadata value associated with the current selection is chosen. Then, the search continues to navigate through the crosslinked network available through the connections of the databases associated with the string search engine.

It is to be noted that any one or more of the aspects and embodiments of process 400 and/or GSBS 100, as described herein, may be conveniently implemented using one or more machines (e.g., one or more computing devices that are utilized as a user computing device) programmed according to the teachings of the present specification, as will be apparent to those of ordinary skill in the computer art. Aspects and implementations of GSBS 100, discussed above, employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., computing device 108, mobile device 110) or a portion of the machine and that causes the machine to perform any one of the methodologies and/or embodiments described herein. Examples of a machine-readable storage medium include, but are not limited to, a magnetic disk, an optical disk, a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as a collection of physically separate media, such as, for example, a collection of compact disks or one or more hard disk drives in combination with a computer memory. As used herein, a machine-readable storage medium does not include a signal.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine and any related information (e.g., data structures and data) that causes the machine to perform any one of the methodologies and/or embodiments described herein.

FIG. 6 shows a diagrammatic representation of one embodiment of computing device 108 in the exemplary form of a computer system 500, within which a set of instructions for causing a processor 504 to perform any one or more of the aspects and/or methodologies, such as process 400, of the present disclosure. It is also contemplated that multiple computing devices or mobile devices or combinations of computing devices and mobile devices may be utilized to implement a specially configured set of instructions for causing GSBS 100 to perform any one or more of the aspects and/or methodologies of the present disclosure.

Computer system 500 can also include a memory 508 that communicate with each other, and with other components, via a bus 512. Bus 512 may include any of several types of bus structures including, but not limited to, a memory bus, a memory controller, a peripheral bus, a local bus, and any combinations thereof, using any of a variety of bus architectures.

Memory 508 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 516 (BIOS), including basic routines that help to transfer information between elements within computer system 500, such as during start-up, may be stored in memory 508. Memory 508 may also include (e.g., stored on one or more machine-readable media) instructions (e.g., software) 520 embodying any one or more of the aspects and/or methodologies of the present disclosure. In another example, memory 508 may further include any number of program modules including, but not limited to, an operating system, one or more application programs, other program modules, program data, and any combinations thereof.

Computer system 500 may also include a storage device 524, such as, but not limited to, the machine readable storage medium described above. Storage device 524 may be connected to bus 512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 524 (or one or more components thereof) may be removably interfaced with computer system 500 (e.g., via an external port connector (not shown)). Particularly, storage device 524 and an associated machine-readable medium 528 may provide nonvolatile and/or volatile storage of machine-readable instructions, data structures, program modules, and/or other data for computer system 500. In one example, software 520 may reside, completely or partially, within machine-readable medium 528. In another example, software 520 may reside, completely or partially, within processor 504.

Computer system 500 may also include an input device 532. In one example, a user of computer system 500 may enter commands and/or other information into computer system 500 via input device 532. Examples of an input device 532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 532 may be interfaced to bus 512 via any of a variety of interfaces (not shown) including, but not limited to, a serial interface, a parallel interface, a game port, a USB interface, a FIREWIRE interface, a direct interface to bus 512, and any combinations thereof. Input device 532 may include a touch screen interface that may be a part of or separate from display 536, discussed further below. Input device 532 may be utilized as a user selection device for selecting one or more graphical representations in a graphical interface as described above.

A user may also input commands and/or other information to computer system 500 via storage device 524 (e.g., a removable disk drive, a flash drive, etc.) and/or network interface device 540. A network interface device, such as network interface device 540 may be utilized for connecting computer system 500 to one or more of a variety of networks, such as network 544, and one or more remote devices 548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network, a telephone network, a data network associated with a telephone/voice provider, a direct connection between two computing devices, and any combinations thereof. A network, such as network 544, may employ a wired and/or a wireless mode of communication. In general, any network topology may be used. Information (e.g., data, software 520, etc.) may be communicated to and/or from computer system 500 via network interface device 540.

Computer system 500 may further include a video display adapter 552 for communicating a displayable image to a display device, such as display device 536. Examples of a display device include, but are not limited to, a liquid crystal display (LCD), a cathode ray tube (CRT), a plasma display, a light emitting diode (LED) display, and any combinations thereof. In addition to a display device, a computer system 500 may include one or more other peripheral output devices including, but not limited to, an audio speaker, a printer, and any combinations thereof. Such peripheral output devices may be connected to bus 512 via a peripheral interface 556. Examples of a peripheral interface include, but are not limited to, a serial port, a USB connection, a FIREWIRE connection, a parallel connection, and any combinations thereof.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of searching strings, comprising:
accessing a searchable database having a plurality of strings, each of which includes a plurality of places, with each place being identified by geolocation coordinates and included in at least one relationship correlating said each place with another place included in the string; and
searching the searchable database for at least one of the plurality of strings using at least one of the relationships as a search term.

2. A method according to claim 1, wherein the at least one relationship includes relative proximity of places included in the plurality of places, further comprising searching the searchable database with respect to a first one of the plurality of places using its relative proximity to a second one of the plurality of places.

3. A method according to claim 1, wherein the at least one relationship includes common authors of places included in the plurality of places, further comprising searching the searchable database with respect to the author of at least one of the plurality of places.

4. A method according to claim 1, wherein the at least one relationship includes a rating of places included in the plurality of places, further comprising searching the searchable database using a rating of at least one of the plurality of places.

5. A method according to claim 1, further comprising searching the searchable database using geolocation coordinates identifying at least one of the plurality of places.

6. A method according to claim 1, wherein said searchable database includes a plurality of narratives, each associated with ones of said plurality of strings, said plurality of narratives being provided by a string author.

7. A method according to claim 6, wherein said plurality of narratives each have a semantic theme, said searching including searching for a semantic theme of the narrative.

8. A system for searching a plurality of strings, comprising:
a computer readable storage medium connectable to a database, said database having a plurality of places stored therein;
a geolocation module configured to record at least one coordinate representative of a position of a place stored in said database;
an input module configured to receive characteristics of said place that are entered by a user;
a string module configured to develop a relationship based upon at least two characteristics of the place, wherein said relationship correlates one of said plurality of places to another one of said plurality of places; and
a search module configured to receive search characteristics from a user and to find at least one relationship matching the search characteristics.

9. A system according to claim 8, wherein the characteristics of the place entered by a user include a narrative associated with the activity.

10. A system according to claim 9, wherein said search module is configured to search for a semantic characteristic of the narrative.

11. A method of searching strings, comprising:
receiving a command to access a searchable database having a plurality of strings stored therein, each of which includes a plurality of places, with each place being identified by geolocation coordinates and included in at least one relationship correlating the each place with another place included in the string; and
searching the searchable database for at least one of the plurality of strings using at least one of the plurality of relationships as a search term.

12. A method according to claim 11, wherein each of the plurality of strings further includes string metadata and wherein each of the plurality of places further includes place metadata, and wherein the string metadata and the place metadata are crosslinked.

13. A method according to claim 11, wherein the searchable database further includes a plurality of users stored therein, each associated with a plurality of strings and a plurality of places.

14. A method according to claim 13, wherein each of the plurality of users further includes a user metadata associated therewith and wherein the user metadata, string metadata, and place metadata are crosslinked.

15. A method according to claim 11, wherein the at least one relationship includes relative proximity of places included in the plurality of places, further comprising searching the searchable database with respect to a first one of the plurality of places using its relative proximity to a second one of the plurality of places.

16. A method according to claim 11, wherein the at least one relationship includes common users of places included in the plurality of places, further comprising searching the searchable database with respect to a user of at least one of the plurality of places.

17. A method of navigating a database having metadata values, comprising:
receiving a query term;
querying the database based upon the query term;
producing a first results list from the output of an algorithm configured to identify metadata values associable with the query term;
selecting a first metadata value from the first results list;
returning a second results list from the metadata values associated with said selecting; and
selecting a second metadata value from the second results list.

18. A method according to claim 17, wherein the first results list is a list of strings created by a user.

19. A method according to claim 18, wherein the second results list is a list of places associated with said selection of a first metadata value.
